(19) United States
(12) Patent Application Publication
(10) Pub. No.: US 2011/0021670 A1
(43) Pub. Date: Jan. 27, 2011

(54) INTEGRATED PROCESS FOR MANUFACTURING A BINDER

(75) Inventors: Aicardo Roa-Espinosa, Madison, WI (US); Hailin Lin, Guangzhou (CN)

Correspondence Address: STEVEN H GREENFIELD, 4649 SEMINOLE TRAIL, GREEN BAY, WI, 54313, US

(73) Assignee: Soil Net LLC, Madison, WI (US)

(21) Appl. No.: 12/509,451

(22) Filed: Jul. 25, 2009

(51) Int. Cl. C09J 189/00; C02F 1/52; C02F 1/56

(52) U.S. Cl. 524/17; 210/723; 210/728; 210/710; 106/124.1; 210/710

(57) ABSTRACT

A process for manufacturing a binder from a waste water effluent is disclosed. A method for recovering the protein used in the manufacture of the binder comprises adding an agglomerating agent to the waste effluent stream, precipitating the protein and separating the water from the protein. The steps for manufacturing the binder from the protein include hydrolyzing the protein, mixing an adhesive polymer with the protein and curing the protein.

### FIELD OF THE INVENTION

The present invention relates to a method of manufacturing a binder from proteins. More specifically it concerns a process of manufacturing a binder from proteins present in various waste water effluent sources.

### DESCRIPTION OF PRIOR ART

Embodiments for the production of protein adhesive binders from vegetable sources have been disclosed in prior art references. U.S. Pat. No. 4,474,694 relates to a process for the production of a modified vegetable protein adhesive binder comprising: forming an alkaline dispersion of a vegetable protein material having reactive disulfide bonds; treating said dispersion with a reducing agent in an amount sufficient to react with the disulfide bonds of said protein material; and reacting said treated dispersion with a carboxylic acid anhydride in an amount sufficient to modify the protein material wherein the pH is maintained between 9 and 10.5 during said reaction and treatment. The protein extract is then separated from the alkali insoluble solids by filtration or centrifugation. U.S. Pat. No. 4,933,087 teaches a process for treating food wastewaters by acidifying to a low pH, adding an alginate, and, preferably, adding lime to a pH of at least 7.0, without adding iron or aluminum to assist in coagulation and flocculation of the wastewater. A floc is formed at acid pH in some wastewaters and at neutral to alkaline pH in other wastewaters treated with lime. Pre-grant publication number 20080142447 refers to processes for the treatment of wastewater comprising incorporating a delaminated nanoparticulate clay into a treatment mixture to form a coagulant. The nanoparticulate clay comprises an anionic coagulant. U.S. Pat. No. 4,554,337 teaches a process for the production of a modified vegetable protein adhesive binder comprising: forming an alkaline dispersion of a vegetable protein material; and treating said dispersion with a cationic monomer selected from the group consisting of cationic epoxide monomers and cationic acrylate monomers in an amount sufficient to modify the protein material. Current processes are typically slow and often require centrifuging to speed the separation of the solids followed by filtration to remove these solids.

### SUMMARY OF THE INVENTION

In one aspect of the present invention, a method for recovering proteins from a waste effluent stream containing proteins and water comprises: blending a coagulant with the waste effluent stream; blending a flocculent with the waste effluent stream; agglomerating the proteins into a protein precipitate; and separating the protein precipitate from the waste effluent stream.

In another aspect of the present invention, a process for manufacturing a binder from a protein source said protein source having a pH below 9.0 comprises: hydrolyzing the protein source; mixing an adhesive polymer with the protein source to form a binder blend; and curing the binder blend.

In yet another aspect of the present invention, an integrated process for manufacturing a binder from a waste effluent comprises: treating the effluent stream with an agglomerating agent to produce a precipitate containing protein, said protein precipitate having a pH below 9.0; separating the precipitate from the waste effluent; hydrolyzing the precipitate; mixing an adhesive polymer with the protein source to form a binder blend; and curing the binder blend.

These and other features, aspects and advantages of the present invention will become better understood with reference to the following drawings, description and claims.

### DETAILED DESCRIPTION OF THE INVENTION

It is the object of the present invention to provide a process for recovering useful proteins from waste effluents generated by a variety of food processes in a manner that does not require centrifugation or filtration. The waste effluents may originate from processes such as starch extraction from fruits and vegetables including but not limited to cassava, corn, potatoes, sweet potatoes and wheat, proteins from effluents in the production of ethanol and proteins from waste effluents in the production of citric acid.

It is also the object of the present invention to provide a process for making a binder having good strength properties from a protein source that uses few steps and can be carried out at room temperature. The protein may originate from vegetables, fruits, plants or animals.

It is further the object of the present invention to provide an integrated process for producing a binder from vegetable protein containing waste effluents generated by a variety of food processes such as starch extraction from fruits and vegetables including but not limited to cassava, corn, potatoes, sweet potatoes and wheat, proteins from effluents in the production of ethanol and proteins from waste effluents in the production of citric acid. Common proteins found in waste effluent from these processes include proline having the chemical formula C₅H₉NO₂, 2-amino-4-carbamoyl butanoic acid, also referred to as glutamine, having the formula C₅H₁₀N₂O₃ and glycine having the chemical formula C₂H₅NO₂.

The present invention process for recovering useful proteins from waste effluents is accomplished by agglomerating the colloidal particle suspension of the protein in the waste water and releasing water out of the suspension that is relatively particle free. In an embodiment of the present invention, two mechanisms are combined to agglomerate the colloidal suspension particles together and to release water that is relatively free of solids: coagulation and flocculation. Coagulation is the destabilization of colloids by neutralizing the forces that keep them apart. Cationic coagulants provide positive electric charges to reduce the negative charge, or zeta potential, of the colloids. As a result, the particles collide to form larger particles referred to as flocs. Flocculation is the action of polymers to form bridges between the flocs and bind the particles into large agglomerates or clumps. Bridging occurs when segments of the polymer chain adsorb on different particles and help particles aggregate. An anionic flocculant typically reacts against a positively charged suspension, adsorbing on the particles and causing destabilization either by bridging or charge neutralization. In order to effectively flocculate a colloidal suspension, a very high molecular weight polymer, typically greater than 1 million atomic mass units is required. Inter-particle bridging can occur with nonionic, cationic or anionic polymers. Both coagulation and flocculation reactions take place as soon as the chemicals make contact with the suspended particles and are virtually instantaneous.

Many factors determine the effectiveness of coagulation and flocculation. Among these are the nature and charge of the colloidal particles, the length, charge and shape of the polymer chain, and the ionic character of the solution. To a great extent, flocculants alone can accomplish the separation of solids and water function fairly effectively. The addition of coagulants, however, makes the separation of the ionic particles and their retention onto the solids more effective and faster.

The coagulants of the present invention include bivalent and trivalent cationic oxides and salts. Examples are calcium chloride, calcium oxide, calcium nitrate, calcium sulfate, magnesium chloride, magnesium nitrate, magnesium sulfate, magnesium oxide, aluminum oxide, aluminum chloride, aluminum nitrate, aluminum sulfate, aluminum chlorohydrate, aluminum perchloride, ferric oxide, and ferric chloride. The coagulants of the present invention also include quaternary polyamines and PolyDADMAC or poly-diallyldimethyl-ammonium chloride (Poly-DADMAC), a cationic branched polyamine acting as a coagulant that is a product of the reaction between dimethylamine and allyl chloride. Diallyldimethyl-ammonium chloride and poly-diallyldimethyl-ammonium chloride are produced by the same reaction shown below, but diallyldimethyl-ammonium chloride is made under conditions that inhibit polymerization while the poly-diallyldimethyl-ammonium chloride is made under conditions that promote polymerization. The molecular weight of the poly-diallyldimethyl-ammonium chloride is ideally between about 10,000 and 1,000,000 atomic mass units.

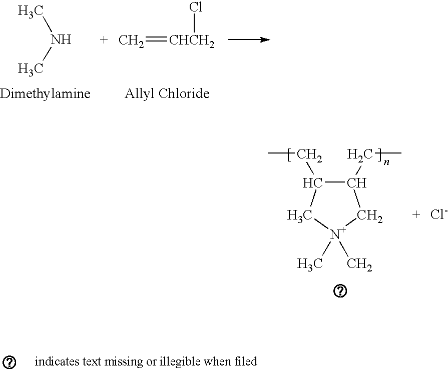

The flocculant polymers suitable for use in the process of the present invention may be anionic, cationic or non-ionic. Flocculant polymers are hydrophilic polymers having a molecular weight ranging from about 1 to about 30 million atomic mass units and a degree of polymerization of between 14,000 and 420,000 monomer units. The flocculants of the present invention may be polyacrylamide homopolymers and have a nonionic nature or they may be copolymers and have a cationic or anionic nature with a degree of ionization varying between 0 and 100%.

In an exemplary embodiment, anionic flocculants are obtained either by hydrolysis of the amide groups on a polyacrylamide chain or by copolymerization of the polyacrylamide with a carboxylic or sulfonic acid salt. A common type of flocculant made by copolymerization is one between an acrylamide and acrylic acid. Another type of flocculant made by copolymerization is one between an acrylamide and sulfonic acid.

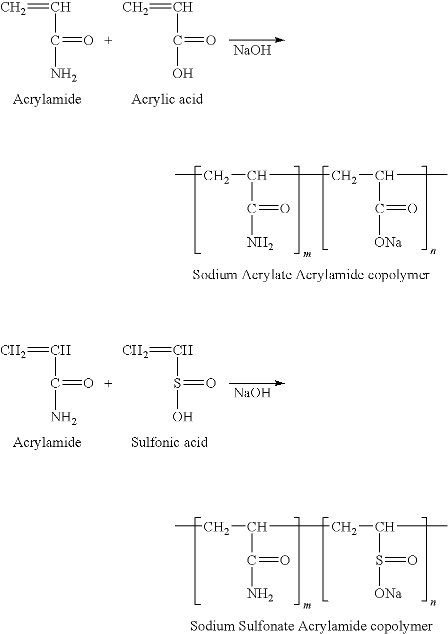

The anionicity of these copolymers can vary between 0% and 100% depending on the ratio of the monomers involved. The anionic copolymers used in the process of the present invention may have a molecular weight ranging between about 3 million to about 30 million atomic mass units, and a viscosity at a concentration of 5 g/l ranging from about 200 centipoises to about 2800 centipoises. The preferred pH for making these copolymers is greater than 7.0.

Another embodiment of an anionic flocculant polymer suitable for use in the process of the present invention is the sodium salt of acrylamide/2-acrylamidomethylpropanesulfonic acid. The pH may be in the range of about 2 to about 12. It should be understood, however, that the scope of the present invention is not limited to these specific flocculant polymers.

An exemplary embodiment of a cationic flocculant suitable for use in the process of the present invention is dimethylaminoethyl acrylate methyl chloride poly-acrylamide copolymer that may be derived from the copolymerization of acrylamide with dimethylaminoethyl acrylate (DMAEA) in quaternized form. A first reaction of dimethylaminoethyl acrylate (DMAEA) with methyl chloride allows it to be converted into a quaternary ammonium salt in the form of chloromethylated dimethylaminoethyl acrylate (DMAEA-MeCl) as can be seen below:

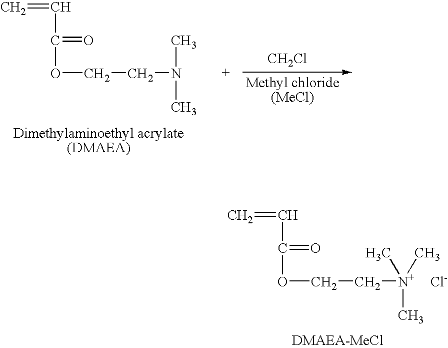

The copolymerization of DMAEA-MeCl with acrylamide produces the cationic polymer.

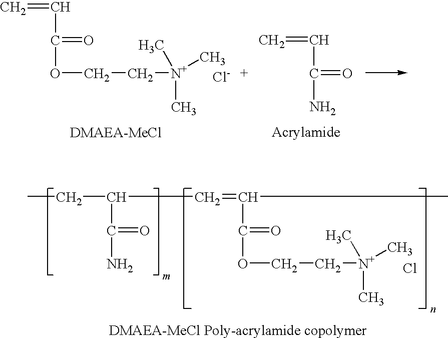

The cationic charge of the copolymer is determined by the ratio of each monomer and may vary between 0 and 100%. Preparation of the copolymer should be carried out at a pH of about 5.5 even though the flocculation is carried out at a higher pH, as the ester group of the copolymer is sensitive to pH levels above 6.0. The molecular weights of the cationic flocculants suitable for use in the application of the present invention may range from about 1 million to about 10 million atomic mass units, and the viscosity at a concentration of about 5 g/l ranges may range from about 100 to about 1700 cps. Other embodiments of cationic flocculant polymers suitable for use in the process of the present invention are acrylamide/acryloylethyltrimethylammoniumchloride, (AM/AETAC by short notation), acrylamide/acrylamidopropyltrimethylammonium chloride or AM/APTAC, and 3-chloro-2-hydroxypropyltrimethylammonium chloride modified starch. It should be understood however that these flocculant polymers are exemplary and that the scope of the present invention is not limited to these specific flocculant polymers.

Nonionic flocculants suitable for use in the process of the present invention are typically acrylamide homopolymers as shown below:

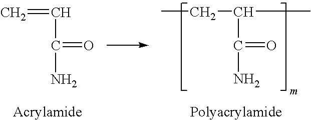

These polymers are called nonionic, even though slight hydrolysis of the amide groups gives them an anionic nature typically with an anionicity of less than 1%. Nonionic polymers containing less than 1% of anionic groups may be obtained under special polymerization conditions.

It is to be understood that this list of coagulants and flocculants disclosed is not exhaustive and others may also be used in the context of the present invention.

In an embodiment of the present invention separation process, the coagulant and flocculant are each dissolved in a water makeup tank each at a concentration of about 1 g/kg of water, or about 0.1%. They can be mixed in and pumped from either separate tanks or mixed together and pumped from the same makeup tank. The coagulant should be dissolved in a slightly acidic environment in a pH range of about 6-6.5 preferably using a weak organic acid such as citric acid, and the flocculant dissolved at an ionic strength of 25%. Where a pH adjustment to >7.0 is required for the flocculant, calcium oxide can be used as the coagulant.

In the present invention process of recovering protein from waste effluent water, a coagulant may be blended with the waste effluent at an amount of between about 1 mg of the coagulant per liter of effluent to about 100 mg of the coagulant per liter of effluent, and preferably between 5 mg of the coagulant per liter of effluent to about 25 mg of the coagulant per liter of effluent. A flocculant may be blended with the waste effluent at an amount of between about 1 mg of the coagulant per liter of effluent to about 25 mg of the flocculant per liter of effluent, and preferably between 10 mg of the flocculant per liter of effluent to about 15 mg of the coagulant per liter of effluent.

Blending the coagulant and flocculant with the effluent waste is done in a holding tank and causes the proteins to agglomerate into a precipitate layer that separates from the water and floats to the top of the tank. The water may be removed by gravity leaving a paste that has a concentration of about 30-40% solids containing mostly protein.

According to an embodiment of the present invention, manufacturing a binder from the paste that results from the process of protein recovery from effluent waste includes the steps of hydrolyzing the protein, mixing the paste with an adhesive polymer, curing the mix of protein and polymer, and, optionally, adding a preservative to the protein. The protein may originate from vegetable, fruit and other plant process effluents. Protein sources from animal live stock processing, including but not limited to blood, milk, fish, and poultry however also fall within the scope of the present invention. The protein may be recovered from the waste effluent stream by means described in the prior art or as disclosed in the present invention. The recovered protein may be provided in a form of a paste having a consistency between about 10% to about 50%, and most typically between 30% to about 40%.

Suitable preservatives in the context of the present invention include diiodomethyl-p-tolylsulfone, sodium azide having the formula NaN₃, sodium borate decahydrate, calcium oxide, citric acid and combinations thereof The hydrolysis of the protein is accomplished by raising the pH to between about 9.0 to about 11.0 with a suitable alkaline solution including but not limited to sodium hydroxide, potassium hydroxide and calcium hydroxide. Citric acid may be used along with the alkali to fine tune the pH adjustment. Curing the mixture of hydrolyzed protein and adhesive polymer includes heating the mixture to a temperature of between about 70° C. and about 120° C. under a pressure ranging from 0.0 to about 1.5 MPa for about 5 minutes.

The hydrolyzed protein may then be mixed with a suitable adhesive polymer such as poly-diallyldimethyl-ammonium chloride, polydicyandiamide, vinyl-acrylic latex and any combinations thereof Good mixing is important in the hydrolysis step to provide a uniform dispersion and reaction of the protein.

Poly-diallyldimethyl-ammonium chloride (Poly-DADMAC), a cationic branched polyamine, is a product of the reaction between dimethylamine and allyl chloride as shown below. The molecular weight of the poly-diallyldimethyl-ammonium chloride is ideally between about 10,000 and 1,000,000 atomic mass units.

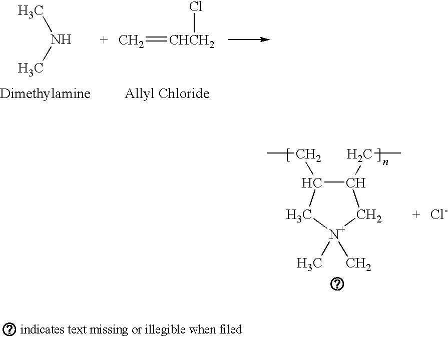

Polydicyandiamide (DMD), a branched polyamine, may be obtained from the reaction of dicyandiamide monomer and formaldehyde as shown below:

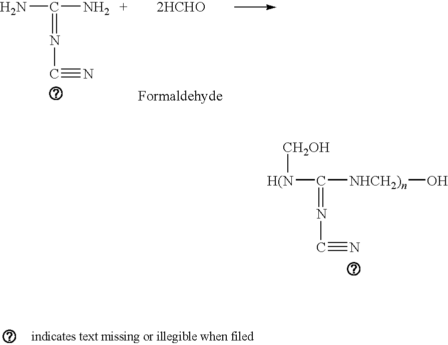

The molecular weight of the polydicyandiamide may be between about 3000 and about 150,000 atomic mass units and has a high cationic charge level.

A vinyl-acrylic latex suitable as an adhesive polymer includes PD-0449 currently marketed by the H. B. Fuller® Company.

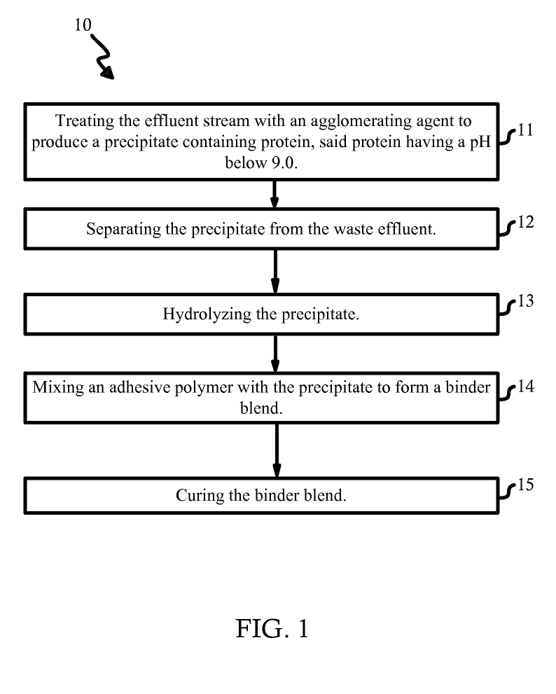

In another embodiment of the present invention, an integrated process for making a binder from a waste effluent containing proteins comprises the steps of: recovering a protein precipitate from the waste effluent, hydrolyzing the protein precipitate, mixing the protein precipitate with an adhesive polymer, curing the protein precipitate and, optionally, blending a preservative with the recovered protein to inhibit any bacterial growth in the manufacturing process. The steps for the process 10 are outlined in FIG. 1.

The waste effluent may originate from a variety of food processes such as starch extraction from fruits and vegetables including but not limited to cassava, corn, potatoes, sweet potatoes and wheat, proteins from effluents in the production of ethanol and proteins from waste effluents in the production of citric acid.

The protein recovery step includes blending an agglomerating agent with the waste effluent stream to agglomerate the proteins into a precipitate and release the water from the effluent which yields a protein paste of a concentration of about 30% to about 40%. In one embodiment of the present invention the agglomerating agent is a flocculant. In another embodiment of the present invention the agglomerating agent is a coagulant and flocculant. Hydrolysis of the protein is accomplished by treating the protein with an alkaline solution that raises the pH to between about 9.0 to about 11.0 Suitable alkalis include sodium hydroxide, potassium hydroxide and calcium hydroxide.

Adhesive polymers suitable for mixing with the protein include poly-diallyldimethyl-ammonium chloride, polydicyandiamide, vinyl-acrylic latex and any combinations thereof Suitable preservatives in the context of the present invention include sodium borate decahydrate, sodium azide, calcium oxide, diiodomethyl-p-tolyl sulfone, citric acid and any combinations thereof. Curing the mixture of hydrolyzed protein and adhesive polymer includes heating the mixture to a temperature of between about 70° C. and about 120° C. under a pressure ranging from about 0.0 to about 1.5 MPa for about 5 minutes.

### EXAMPLES

### Example 1

### Protein Recovery

Protein source: Waste water from corn processing, yeast processing, whey processing, and soybean processing.
Flocculant: sodium acrylate acrylamide copolymer added at 12 parts per million to the waste water effluent.
Coagulant: aluminum chlorohydrate added at 12 parts per million to the waste water effluent.
Conditions: neutral pH, temperature of 35° C.
Separation time of the protein from effluent: about 15 seconds
The recovered protein precipitate has a concentration of around 30% solids.

### Binder Manufacturing

Preservative: 1 ml of sodium borate and 1 g of lime added to 100 g of protein at 30% solids followed by mixing and waiting for 4 minutes.
Alkali: 4 mls of sodium hydroxide at concentration of 30% followed by mixing and waiting for 4 minutes.
Hydrolysis conditions: pH 10, room temperature.
Adhesive polymer: none.
For the dry test, the 1.2 cm×1.2″ cm×0.8 cm strips were tested using an MTS tensile tester
For the wet test, the 1.2 cm×1.2″ cm×0.8 cm strips were soaked in water under vacuum for 30 min. The soaked specimens were tested using the MTS tensile tester immediately after removing them from the water bath.
Curing conditions: a temperature of 120° C. and a pressure of 1.24 MPa for 5 minutes.
Adhesion test results from applying the binder to pine wood surfaces:

| | Source | | | | |
|---|---|---|---|---|---|
| Tests | Corn | Yeast | Whey | Soy | Control: PVA |
| Dry Tensile, N | 1233 | 1176 | 1268 | 1135 | 843 |
| Wet Tensile, N | 213 | 265 | 245 | 204 | 0 |

### Example 2

### Protein Recovery

Protein source: Waste water from corn processing.
Flocculant: sodium acrylate acrylamide copolymer added at 12 parts per million to the waste water effluent.
Coagulant: aluminum chlorohydrate added at 12 parts per million to the waste water effluent.
Conditions: neutral pH, temperature of 35° C.
Separation time of the protein from effluent: about 15 seconds
The recovered protein precipitate has a concentration of around 30% solids.

### Binder Manufacturing

Preservative: 1 ml of sodium borate and 1 g of lime added to 100 g of the recovered protein at 30% solids followed by mixing and waiting for 4 minutes.
Alkali: 4 mls of sodium hydroxide at concentration of 30% followed by mixing and waiting for 4 minutes.
Hydrolysis conditions: pH 10, room temperature
Adhesive polymer: Vinyl-acrylic latex PD-0449 from the H. B. Fuller® Company, added to result in the following ratios of recovered corn protein to undiluted adhesive polymer: 100/0, 80/20, 70/30, 50/50, and 0/100.
For the dry test, the 1.2 cm×1.2″ cm×0.8 cm strips were tested using an MTS tensile tester
For the wet test, the 1.2 cm×1.2″ cm×0.8 cm strips were soaked in water under vacuum for 30 min. The soaked specimens were tested using the MTS tensile tester immediately after removing them from the water bath.
Curing conditions: a temperature of 120° C. and a pressure of 1.24 MPa for 5 minutes.
Adhesion test results from applying the binder to pine wood surfaces:

| | ratio of recovered | | | | | |
|---|---|---|---|---|---|---|
| | protein and adhesive polymer | | | | | (Control) Phenol |
| Tests | 100/0 | 80/20 | 70/30 | 50/50 | 0/100 | formaldehyde |
| Dry Tensile, N | 1233 | 1355 | 1409 | 1485 | 1632 | 1611 |
| Wet Tensile, N | 213 | 661 | 599 | 754 | 910 | 760 |

### Example 3

### Protein Recovery

Protein source: Waste water from corn processing.
Flocculant: sodium acrylate acrylamide copolymer added at 12 parts per million to the waste water effluent.
Coagulant: aluminum chlorohydrate added at 12 parts per million to the waste water effluent.
Conditions: neutral pH, temperature of 35° C.
Separation time of the protein from effluent: about 15 seconds
The recovered protein precipitate has a concentration of around 30% solids.

### Binder Manufacturing

Preservative: 1 ml of sodium borate and 1 g of lime added to 100 g of the recovered protein at 30% solids followed by mixing and waiting for 4 minutes.
Alkali: 4 mls of sodium hydroxide at concentration of 30% followed by mixing and waiting for 4 minutes.
Hydrolysis conditions: pH 10, room temperature
Adhesive polymer: poly-diallyldimethyl-ammonium chloride, added to result in the following ratios of recovered corn protein to undiluted adhesive polymer: 100/0, 80/20, 70/30, 50/50, and 0/100.
For the dry test, the 1.2 cm×1.2″ cm×0.8 cm strips were tested using an MTS tensile tester
For the wet test, the 1.2 cm×1.2″ cm×0.8 cm strips were soaked in water under vacuum for 30 min. The soaked specimens were tested using the MTS tensile tester immediately after removing them from the water bath.
Curing conditions: a temperature of 120° C. and a pressure of 1.24 MPa for 5 minutes.
Adhesion test results from applying the binder to pine wood surfaces:

| | ratio of recovered | | | | | |
|---|---|---|---|---|---|---|
| | protein and adhesive polymer | | | | | (Control) Phenol |
| Tests | 100/0 | 80/20 | 70/30 | 50/50 | 0/100 | formaldehyde |
| Dry Tensile, N | 1233 | 1276 | 1295 | 1187 | 1225 | 1611 |
| Wet Tensile, N | 213 | 226 | 233 | 218 | 225 | 760 |

### Example 4

### Protein Recovery

Protein source: Waste water from whey processing.
Flocculant: sodium acrylate acrylamide copolymer added at 12 parts per million to the waste water effluent.
Coagulant: aluminum chlorohydrate added at 12 parts per million to the waste water effluent.
Conditions: neutral pH, temperature of 35° C.
Separation time of the protein from effluent: about 15 seconds
The recovered protein precipitate has a concentration of around 30% solids.

### Binder Manufacturing

Preservative: 1 ml of sodium borate and 2 g of lime added to 100 g of the recovered protein at 30% solids followed by mixing and waiting for 4 minutes.
Alkali: 4 mls of sodium hydroxide at concentration of 30% followed by mixing and waiting for 4 minutes.
Hydrolysis conditions: pH 10, room temperature
Adhesive polymer: polydicyandiamide, added to result in the following ratios of recovered corn protein to undiluted adhesive polymer: 100/0, 80/20, 70/30, 50/50, and 0/100.
For the dry test, the 1.2 cm×1.2″ cm×0.8 cm strips were tested using an MTS tensile tester
For the wet test, the 1.2 cm×1.2″ cm×0.8 cm strips were soaked in water under vacuum for 30 min. The soaked specimens were tested using the MTS tensile tester immediately after removing them from the water bath.
Curing conditions: a temperature of 120° C. and a pressure of 1.24 MPa for 5 minutes.
Adhesion test results from applying the binder to pine wood surfaces:

| | ratio of recovered | | | | | |
|---|---|---|---|---|---|---|
| | protein and adhesive polymer | | | | | (Control) Phenol |
| Tests | 100/0 | 80/20 | 70/30 | 50/50 | 0/100 | formaldehyde |
| Dry Tensile, N | 1233 | 1302 | 1377 | 1412 | 1450 | 1611 |
| Wet Tensile, N | 213 | 139 | 256 | 267 | 265 | 760 |

### Example 5

### Protein Recovery

Protein source: Waste water from soybean processing.
Flocculant: sodium acrylate acrylamide copolymer added at 12 parts per million to the waste water effluent.
Coagulant: aluminum chlorohydrate added at 12 parts per million to the waste water effluent.
Conditions: neutral pH, temperature of 35° C.
Separation time of the protein from effluent: about 15 seconds
The recovered protein precipitate has a concentration of around 30% solids.

### Binder Manufacturing

Preservative: 1 ml of sodium borate and 1 g of lime added to 100 g of the recovered protein at 30% solids followed by mixing and waiting for 4 minutes.
Alkali: 4 mls of sodium hydroxide at concentration of 30% followed by mixing and waiting for 4 minutes.
Hydrolysis conditions: pH 10, room temperature
Adhesive polymer: polydicyandiamide, added to result in the following ratios of recovered corn protein to undiluted adhesive polymer: 100/0, 80/20, 70/30, 50/50, and 0/100.
For the dry test, the 1.2 cm×1.2″ cm×0.8 cm strips were tested using an MTS tensile tester
For the wet test, the 1.2 cm×1.2″ cm×0.8 cm strips were soaked in water under vacuum for 30 min. The soaked specimens were tested using the MTS tensile tester immediately after removing them from the water bath.
Curing conditions: a temperature of 120° C. and a pressure of 1.24 MPa for 5 minutes.
Adhesion test results from applying the binder to pine wood surfaces:

| | ratio of recovered | | | | | |
|---|---|---|---|---|---|---|
| | protein and adhesive polymer | | | | | (Control) Phenol |
| Tests | 100/0 | 80/20 | 70/30 | 50/50 | 0/100 | formaldehyde |
| Dry Tensile, N | 1233 | 1302 | 1377 | 1412 | 1450 | 1611 |
| Wet Tensile, N | 213 | 139 | 256 | 267 | 265 | 760 |

We claim:

1. A method for recovering proteins from a waste effluent stream containing proteins and water comprising:
blending a coagulant with the waste effluent stream;
blending a flocculant with the waste effluent stream;
agglomerating the proteins into a protein precipitate; and
separating the protein precipitate from the waste effluent stream.

2. The method of claim 1 wherein the coagulant is selected from a list consisting of calcium chloride, calcium oxide, calcium nitrate, calcium sulfate, magnesium chloride, magnesium nitrate, magnesium sulfate, magnesium oxide, aluminum oxide, aluminum chloride, aluminum nitrate, aluminum sulfate, aluminum chlorohydrate, aluminum perchloride, ferric oxide, ferric chloride, quaternary polyamines, Poly-Diallyldimethyl-Ammonium Chloride, and any combinations thereof.

3. The method of claim 1, in which the flocculant polymer is anionic.

4. The method of claim 1, in which the flocculant polymer is cationic.

5. The method of claim 1, in which the flocculant polymer is non-ionic.

6. The method of claim 1, in which the flocculant polymer is a polyacrylamide.

7. The method of claim 3, wherein the anionic flocculant polymer is selected from the group consisting of sodium acrylate acrylamide copolymer, the sodium salt of Acrylamide/2-acrylamidomethylpropanesulfonic acid, sodium sulfonate acrylamide copolymer and any combinations thereof.

8. The method of claim 4, wherein the cationic flocculant polymer is selected from the group consisting of acrylamide/acryloylethyltrimethylammoniumchloride, acrylamide/acrylamidopropyltrimethylammonium chloride and 3-chloro-2-hydroxypropyltrimethylammonium chloride modified starch, dimethylaminoethyl acrylate methyl chloride poly-acrylamide copolymer and any combinations thereof.

9. The method of claim 5, wherein the nonionic flocculant polymer is polyacrylamide homopolymer.

10. A process for manufacturing a binder from a protein source, said protein source having a pH below 9.0 comprising:
hydrolyzing the protein source;
mixing an adhesive polymer with the protein source to form a binder blend; and
curing the binder blend.

11. The process of claim 10, wherein the protein source originates from waste effluent streams generated in processes to extract food ingredients from vegetables, fruits and plants.

12. The process of claim 10, wherein hydrolyzing the protein source comprises adjusting the pH of the protein source to a range between about 9.0 to about 11.0.

13. The process of claim 10, wherein the adhesive polymer is selected from the group consisting of poly-diallyldimethyl-ammonium chloride, polydicyandiamide, vinyl-acrylic latex and any combinations thereof.

14. The process of claim 10, wherein curing the binder blend comprises heating the blend to a temperature range between about 70° C. and about 120° C. under pressure.

15. The process of claim 10 further comprising blending a preservative with the protein source.

16. The process of claim 15, wherein the preservative is selected form the group consisting of sodium borate decahydrate, sodium azide, calcium oxide, Diiodomethyl-p-tolyl sulfone, citric acid and any combinations thereof.

17. An integrated process for manufacturing a binder from a waste effluent comprising:
treating the effluent stream with an agglomerating agent to produce a precipitate containing protein, said protein having a pH below 9.0;
separating the precipitate from the waste effluent;
hydrolyzing the precipitate;
mixing an adhesive polymer with the precipitate to form a binder blend; and
curing the binder blend.

18. The integrated process of claim 17 further comprising adding a preservative.

19. The integrated process of claim 17, wherein the agglomerating agent comprises a flocculant.

20. The integrated process of claim 17, wherein the agglomerating agent comprises a coagulant and a flocculant.

21. The integrated process of claim 17, wherein hydrolyzing the protein comprises blending a suitable alkali with the protein and adjusting the pH to between 9.0 and 11.0.

22. The integrated process of claim 21, wherein the alkali is selected from the group consisting of sodium hydroxide, potassium hydroxide and calcium hydroxide.

23. The process of claim 17, wherein the adhesive polymer is selected from the group consisting of poly-diallyldimethyl-ammonium chloride, polydicyandiamide, vinyl-acrylic latex and any combinations thereof.

24. The process of claim 17, wherein curing the binder blend comprises heating the blend to a temperature range between about 70° C. and about 120° C. under pressure.
